(19) United States
(12) Patent Application Publication
(10) Pub. No.: US 2013/0044039 A1
(43) Pub. Date: Feb. 21, 2013

(54) CERAMIC ANTENNA

(71) Applicant: CHIA-CHING WU, Tu-Cheng (TW)

(72) Inventor: CHIA-CHING WU, Tu-Cheng (TW)

(73) Assignee: HON HAI PRECISION INDUSTRY CO., LTD., Tu-Cheng (TW)

(21) Appl. No.: 13/223,301

(22) Filed: Aug. 31, 2011

(30) Foreign Application Priority Data
Aug. 19, 2011 (TW) 100129656

(51) Int. Cl. H01Q 1/50

(52) U.S. Cl. 343/850

(57) ABSTRACT

A ceramic antenna includes a ceramic body, a first conductor, a second conductor, four metal poles, and eight metal pads. The first conductor and the second conductor are positioned on a same plane and form a coupling capacitor. Two metal poles of the four metal poles extend through the ceramic body and the first conductor. The other two metal poles extend through the ceramic body and the second conductor. The eight metal pads are defined in two opposite surfaces of the ceramic body. Two ends of each metal pole contact two metal pads respectively. When the ceramic body is installed in the electronic device, one of the four poles is used as a feeder of the ceramic antenna, and the other three poles are used as grounds of the ceramic antenna.

### BACKGROUND

1. Technical Field

The present disclosure relates to a ceramic antenna.

2. Description of Related Art

Generally, due to a feeder and a ground of an antenna being set at fixed locations on the antenna, the antenna is installed at a designated position in the electronic device and the position of the antenna cannot be changed and other components of the electronic device must be accommodatingly placed, this lack of flexibility is undesirable.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of a ceramic antenna in accordance with an exemplary embodiment.

FIG. 2 is a top view of the ceramic antenna of FIG. 1.

FIG. 3 is a front view of the ceramic antenna of FIG. 1.

### DETAILED DESCRIPTION

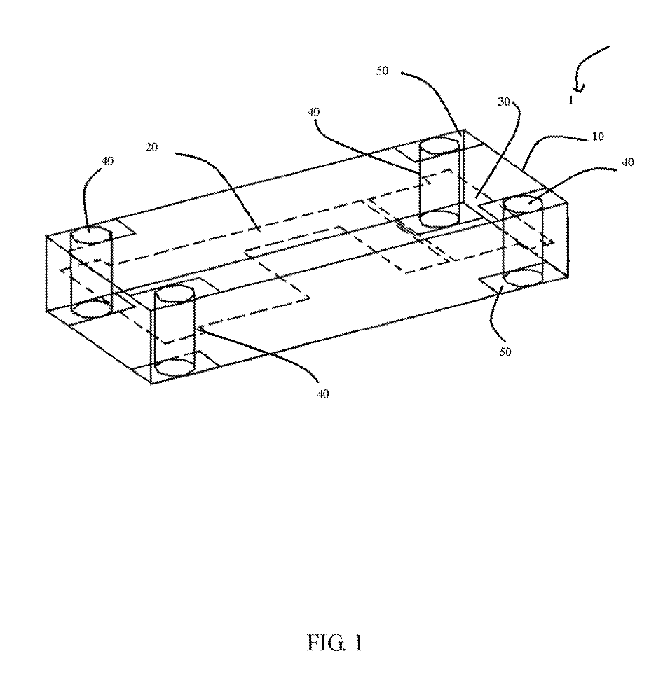

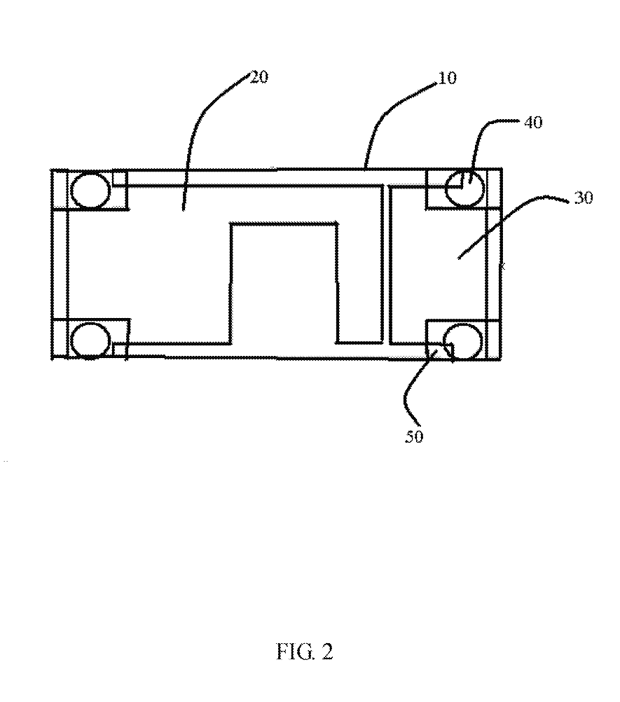

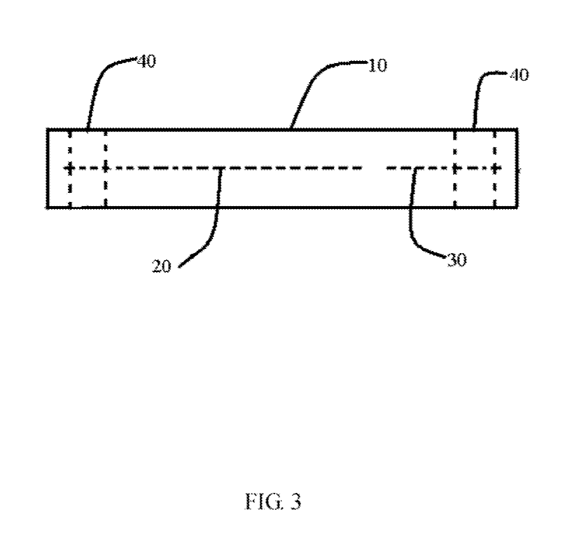

Referring to FIGS. 1-2, a ceramic antenna 1 includes a ceramic body 10, a first conductor 20, a second conductor 30, four metal poles 40, and eight metal pads 50. Referring to FIG. 3, the first conductor 20 and the second conductor 30 are positioned in the middle of the ceramic body 10. The first conductor 20 and the second conductor 30, which are positioned on the same plane, are spaced apart and form a coupling capacitor. Two metal poles 40 extend through the body 10 and the first conductor 20. The other two metal poles 40 extend through the body 10 and the second conductor 30. The eight metal pads 50, defined at two opposite surfaces of the body 10, are for connecting the ceramic antenna 1 to a main circuit of an electronic device (not shown).

Two ends of each of the four metal poles 40 contact two metal pads 50 respectively. When the ceramic body 10 is installed to the electronic device, any one of the four poles 40 can be used as a feeder of the ceramic antenna 10, and the other three poles 40 are used as grounds of the ceramic antenna 10. Thus, a symmetrical antenna is obtained. Due to the symmetry of the ceramic antenna 1, the ceramic antenna 1 can be installed at different places in the electronic device.

In the present embodiment, the ceramic body 10 is cuboid. The ceramic body 1 can be other shapes in other embodiments.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A ceramic antenna comprising:
a ceramic body;
a first conductor and a second conductor, positioned on a same plane in the ceramic body, spaced apart and forming a coupling capacitor;
four metal poles, two metal poles of which pass through the ceramic body and the first conductor, and the other two metal poles of which pass through the ceramic body and the second conductor; and
eight metal pads defined in two opposite surfaces of the ceramic body, for connecting the ceramic antenna to a main circuit of an electronic device;
wherein two ends of each of the four metal poles contact two of the eight metal pads, respectively, when the ceramic body is installed to the electronic device, any one of the four poles is used as a feeder of the ceramic antenna, and the other three poles are used as grounds of the ceramic antenna.

2. The ceramic antenna as described in claim 1, wherein the first conductor and the second conductor are positioned on the same plane in the middle of the ceramic body

3. The ceramic antenna as described in claim 2, wherein the ceramic body is cuboid-shaped.
